(19) United States
(12) Patent Application Publication
(10) Pub. No.: US 2015/0371661 A1
(43) Pub. Date: Dec. 24, 2015

(54) Conveying Audio Messages to Mobile Display Devices

(71) Applicant: Headcastlab Limited, Exeter (GB)

(72) Inventors: Christopher Chapman, Falmouth (GB); Stephen Longhurst, Southampton (GB); William Donalds Fergus McNeill, Southampton (GB)

(21) Appl. No.: 14/764,657

(22) PCT Filed: Feb. 4, 2014
(86) PCT No.: PCT/GB2014/000041

§ 371 Date: Jul. 30, 2015

(30) Foreign Application Priority Data
Feb. 4, 2013 (GB) 1301981.5
May 10, 2013 (GB) 1308522.0
May 10, 2013 (GB) 1308523.8
May 10, 2013 (GB) 1308525.3

(51) Int. Cl. G10L 21/10; G06T 13/40

(52) U.S. Cl. CPC G10L 21/10; G06T 13/40; G10L 2021/105

(57) ABSTRACT

An apparatus and method includes a graphics station, an internet server and a production device, such that, at the graphics station, a character data file is created; a speech animation loop is generated having lips control; at the production device, the character data file is obtained along with the speech animation loop from the internet server; local audio is received to produce associated audio data and a control signal to animate the lips, a primary animation data file is constructed with lip movement; at each mobile display device, the character data is received; the primary animation data file and the associated audio data are also accepted; the character data file and the primary animation data file produce primary rendered video data, and the primary rendered video data is played with the associated audio data, such that the movement of the lips is in synchronism with the audio being played.

### CROSS REFERENCE TO RELATED APPLICATIONS

This application claims priority from United Kingdom Patent Application No. 13 01 981.5, filed 4 Feb. 2013; United Kingdom Patent Application No. 13 08 522.0, filed 10 May 2013; United Kingdom Patent Application No. 13 08 523.8, filed 10 May 2013; and United Kingdom Patent Application No. 13 08 525.3, filed 10 May 2013; the entire disclosures of which are incorporated herein by reference in their entirety.

### BACKGROUND OF THE INVENTION

1. Field of the Invention

The present invention relates to an apparatus for conveying an audio message to a plurality of mobile display devices. The present invention also relates to a method of conveying an audio message to a plurality of mobile display devices. The present invention also relates to methods of playing an audio message at a mobile display device.

2. Description of the Related Art

It is known to use computer based techniques in order to produce animations. In particular, it is known for characters to be created in a three dimensional work space as a hierarchical model, such that individual components of the model may move relatively so as to invoke natural movements of a character. It is also known to synchronize these movements to an audio track and to synchronize the lips of the character and thereby create the illusion of the character speaking.

Computer generated character animation has traditionally be used in high-end applications, such as movies and television commercials. However, it has been appreciated that other applications could deploy this technique if it became possible to develop a new type of workflow.

The transmission of data electronically from a source to a single destination is well known. The broadcasting of material is also well known in environments such as television, where every user with an appropriate receiver is in a position to receive the broadcast material. More recently, broadcasts have been made over networks to limited user groups, who either have privileged access (within a corporate environment for example) or have made a subscription or a request for particular broadcast material to be received. Typically, material of this form is conveyed as audio data or, in alternative applications, it may be submitted as video data. Many sources make material of this type available, some on a subscription basis.

It is also known that good quality video production tends to be expensive and requires actors conveying an appropriate level of competence in order to achieve professional results. An animation can provide an intermediate mechanism in which real life video is not required but a broadcast having a quality substantially near to that of a video production can be generated. However, the generation of animations from computer generated characters requires a substantial degree of skill, expertise and time; therefore such an approach would have limited application. A problem therefore exists in terms of developing a workflow which facilitates the production of animations for distribution to selected users as a broadcast.

### BRIEF SUMMARY OF THE INVENTION

According to an aspect of the present invention, there is provided an apparatus for conveying an audio message to a plurality of mobile display devices, comprising a graphics station, an internet server and a production device, wherein: in response to manual input, said graphics station is configured to: create a character data file for a character having animatable lips; generate a speech animation loop having a lips control for moving said animatable lips in response to a control signal; and upload said character data file and said speech animation loop to said internet server; said production device is configured to: obtain said character data file and said speech animation loop from said internet server; receive local audio to produce associated audio data and a said control signal to animate the lips; construct a primary animation data file with lip movement from said character data, said speech animation loop and said control signal; and transmit said primary animation data file and said associated audio data to said internet server; and each said mobile display device is configured to: receive said character data from said internet server; accept said primary animation data file and said associated audio data from the internet server; process said character data file and said primary animation data file to produce primary rendered video data; and play said primary rendered video data with said associated audio data, such that the movement of said lips shown in said primary rendered video data when played is substantially in synchronism with the audio being played.

In an embodiment, the graphics station is configured to generate an idle animation loop; and said production device is configured to produce said primary animation file from the idle animation loop and the speech animation loop.

In an embodiment, the graphics station is also configured to produce an alternative animation sequence and each said mobile display device is configured to; receive said alternative animated sequence; respond to a manual action by producing alternative rendered video data; and play said alternative rendered video data as an alternative to said primary rendered video data.

In an embodiment, a platform is selected from said graphics station and said production device, configured to produce an alternative audio data file; each said mobile display device is configured to receive said animated audio data file; and each said mobile display device is configured to play said alternative audio file with said alternative rendered video data. Thus, it is possible for alternative audio to be produced at the graphics station for a specific character. This may be used at the production device. However, in an alternative embodiment, it is possible for audio generated at the graphics station to be replaced by audio generated at the production station.

In an embodiment, the playing of the primary rendered video data resumes after the playing of the alternative rendered video data.

It is possible for a unique character data set to be produced for each animation file and each associated audio. However, in a preferred embodiment, the character data, being an expensive asset, is used many times after being downloaded to a mobile device. Thus, in an embodiment, the character data is received once and many first animation data files are accepted with associated audio data, wherein each example of a first animation data file is rendered to video with use of a single instance of said character data.

In an embodiment, the internet server is configured to download instructions to a requesting mobile device; and upon installing said instructions, said requesting mobile device is provided with the functionality of the production device. Thus, having experienced the receipt of an animation, it is possible for a user to upgrade, such that they themselves can make animations of this type. To facilitate these operations, the user may be provided with standard graphic characters for which animations, with audio, may be generated.

It is possible for the audio data to be provided as a downloaded file in a way substantially similar to that in which the animation file is downloaded. However, in an embodiment, an animation file is accepted as a downloaded file; audio data is accepted by a process of streaming; and the audio data is played substantially in synchronism with the rendered video data while the audio data is being streamed.

According to a second aspect of the present invention, there is provided a method of conveying an audio message to a plurality of mobile display devices, comprising the steps of; receiving manual input at a graphics station, such that said graphics station performs the steps of: creating a character data file for a character having animatable lips; and generating a speech animation loop having a lips control for moving said animatable lips in response to a control signal; uploading said character data file and said speech animation loop from said graphics station; downloading said character data file and said speech animation loop to a production device; said production device performing the steps of: receiving local audio; producing associated audio data and a said control signal to animate the lips from said audio data; constructing a primary animation data file with lip movement, from said character data, said speech animation loop and said control signal; transmitting said primary animation data file and said associated audio data from said production station; at a mobile display device, receiving said character data and accepting said primary animation data file and said associated audio data; and each mobile display device performs the steps of: processing said character data file with said primary animation data file to produce primary rendered video data; and playing said primary rendered video data with said associated audio data, such that the movement of the lips shown in said primary rendered video data when played is substantially in synchronism with the audio being played.

In an embodiment, the uploading of data and the downloading of data occurs with the respect to a unified internet server. However, it should be appreciated that uploading and downloading may occur via the internet but the physical serving apparatus may be distributed. As is known in the art, it would also be necessary to scale the server functionality as demand for the service grows. To encourage further demand for the service, it is possible for mobile devices to obtain the functionality of a production station. Thus, in an embodiment, the method performs the further steps of: receiving a request at said internet server from a mobile display device for additional functionality; and, in response of said request, downloading instructions to a requesting mobile display device to provide said mobile display device with the functionality of a production device to perform the steps of: downloading an upgrade character data file and an upgrade speech animation loop from a production device; an upgraded production device performing the steps of receiving local audio; producing associated audio data, and a control signal to animate the lips from said audio; and constructing a primary animation data file with lip movement, from said character data, said speech animation loop and said control signal.

According to a third aspect of the present invention, there is provided a method of playing an audio message at a mobile display device, comprising the steps of: receiving a character data file, downloading a primary animation file, downloading an alternative animation sequence and accepting audio data associated with said primary animation file; processing said character data with said primary animation data file to produce primary rendered video data; playing said primary rendered video data with said associated audio data, such that the movement of the lips shown in the primary rendered video data when played is substantially in synchronism with the audio being played; responding to a mechanical interaction by producing alternative video data from said alternative animation sequence; and playing said alternative video data instead of said primary rendered video data.

In an embodiment, an alternative audio data file is produced; each mobile display device receives said alternative audio data file; and each mobile display device plays said alternative audio data file with the alternative rendered video data. In an embodiment, the playing of the primary rendered video data may resume after the playing of the alternative rendered video data.

According to a fourth aspect of the present invention, there is provided a method of playing an audio message at a mobile display device, comprising the steps of: receiving a character data file; downloading a primary animation file; processing said character data file with said primary animation file to produce primary rendered video data; and playing said primary rendered video data with associated audio data; wherein: said associated audio data is streamed, such that the playing of video with substantially synchronized audio is initiated before all of the audio data has been received.

In an embodiment, an alternative animation sequence is downloaded to the mobile display device with alternative audio data; a manual action performed upon the mobile display device is detected; alternative rendered video data is derived from said alternative animation sequence and played with alternative audio data; and the playing of said primary rendered video with streamed associated audio data is resumed.

### BRIEF DESCRIPTION OF THE DRAWINGS

FIG. 1 shows an environment for the generation of audio and visual data;

FIG. 2 shows a functional representation of data flow;

FIG. 3 shows an example of a word station for a character artist;

FIG. 4 shows an example of a hierarchical model;

FIG. 5 shows a time line detailing a plurality of tracks;

FIG. 6 shows a source data file;

FIG. 7 shows a production station;

FIG. 8 shows a schematic representation of operations performed at the production station;

FIG. 9 shows activities performed by a processor identified in FIG. 8;

FIG. 10 shows a viewing device in operation;

FIG. 11 shows a schematic presentation of the viewing device identified in FIG. 10;

FIG. 12 shows an alternative data source file;

FIG. 13 shows an alternative schematic representation of operations performed within the environment of FIG. 7;

FIG. 14 shows a distribution file containing audio data, primary animation data and alternative animation data;

FIG. 15 shows procedures performed at a hosting server; and

FIG. 16 shows communications between a hosting server and display devices.

### DETAILED DESCRIPTION OF EXAMPLE EMBODIMENTS

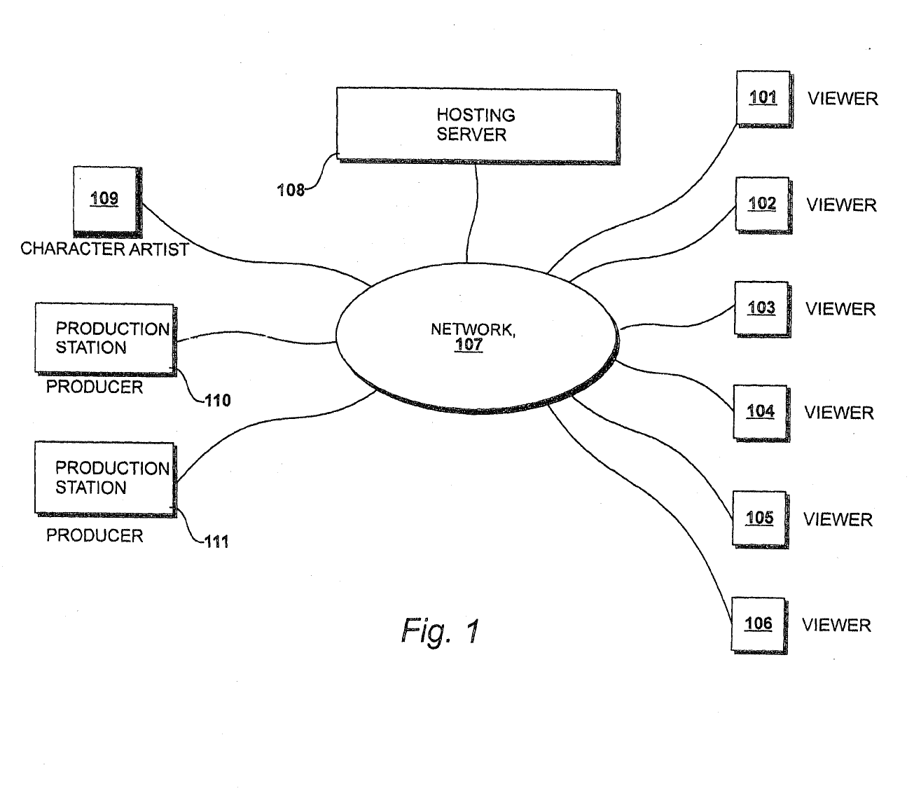

### FIG. 1

An environment for the generation of audio and visual data is illustrated in FIG. 1. A plurality of end user display devices 101, 102, 103, 104, 105 and 106 are shown. Each device 101 to 106 communicates via a network 107. In an embodiment, devices 101 to 106 are hand held devices, such as mobile cellular telephones, communicating within a wireless environment or within a cellular telephony environment.

The overall system is controlled via a hosting server 108; with all material being uploaded to server 108 for storage or downloaded from server 108 when required for further manipulation or when being supplied to an end user display, device (101 to 106) for viewing. Alternatively, and as is known in the art, the functionality of the hosting server 108 may be distributed over a plurality of platforms and different physical hardware systems may be used for different types of communications.

Animatable character data is generated at a graphics station 109 by a character artist using conventional tools for the generation of character data. In an embodiment, character data is initially uploaded to the hosting server 108 and from here it may be downloaded to a production station. In the example shown in FIG. 1, a first production station 110 is present along with a second production station 111.

In an embodiment, character data may be made for a plurality of characters. In this example, a first producer at station 110 may be responsible for generating animation data for a first character and the second producer at station 111 may be responsible for producing animation data for a second character. Thus, in an embodiment, for each individual character, character data may be produced once and based on this, many individual animation data sets may be generated. Thus, a labour intensive exercise of generating the character data is performed once and the relatively automated process of producing specific animation data sets may make use of the character data many times.

In alternative embodiments, each character may have a plurality of data sets and producers may be responsible for the generation of animation data for a plurality of characters. However, in an embodiment, it is envisaged that each producer would be responsible for their own character, such that they would locally generate audio input and that their own character would be automatically animated in order to lip sync with this audio input. For some producers, the content could be relatively light hearted and the animated character could take the form of caricature. Alternatively, the content could be informational, educational or medical, for example, with the tone being more serious and the animated character taking on an appropriate visual appearance.

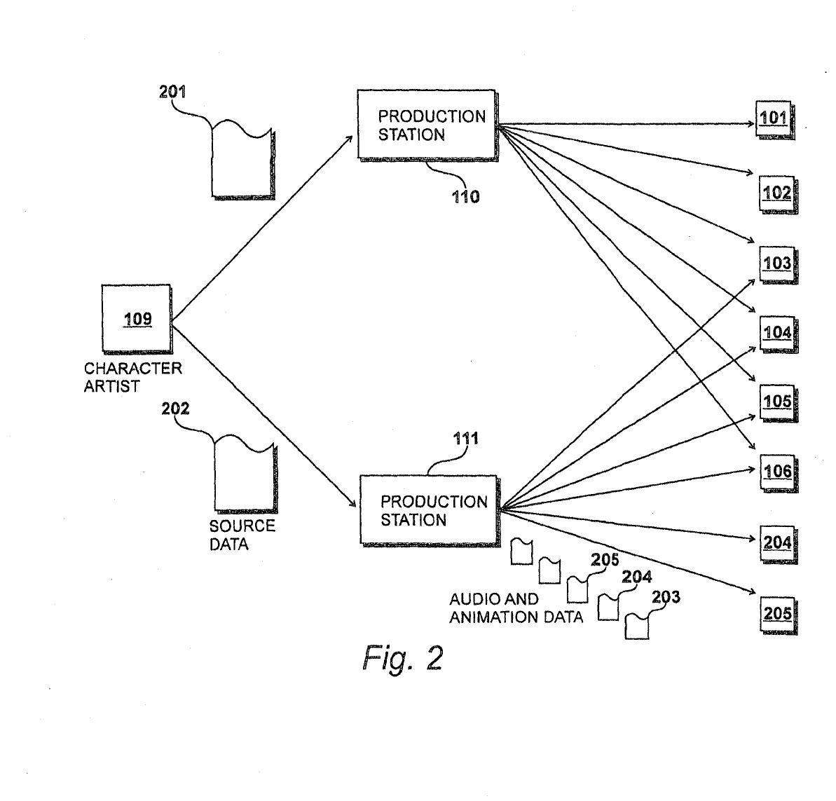

### FIG. 2

A functional representation of dataflow is illustrated in FIG. 2; operating within the physical environment in FIG. 1. For this example, the character artist at graphics station 109 generates a first source data set 201 that is supplied to the first production station 110. In addition, in this example, the character artist 109 produces a second source data set 202 that is supplied to the second production station 111. Thus, in this example, character data (included as part of source data 202) has been supplied to the second production station 111. The highly skilled character artist working with professional tools is only required to produce the source data for each character. The character artist does not produce actual animations. With the source data made available to a producer, the producer can use it many times to produce individual animations based on locally generated audio in a highly technically supported environment; requiring little skill on the part of the producer. Hence talent can easily act as their own producer and produce their own animated assets.

At the second producer 111, audio data is received and animation data is produced for the character in response to the audio data. The character data 203, the audio data 204 and the animation 205 are supplied from the production station 111 to a display device, such as display device 205 shown in FIG. 2. At the display device 205, the animation data is rendered in response to the data that has been received from the production station 111. Thus, animation data (having a relatively small volume) is transmitted from the production station 111 to the display device 205 and output video data is produced by performing a local rendering operation.

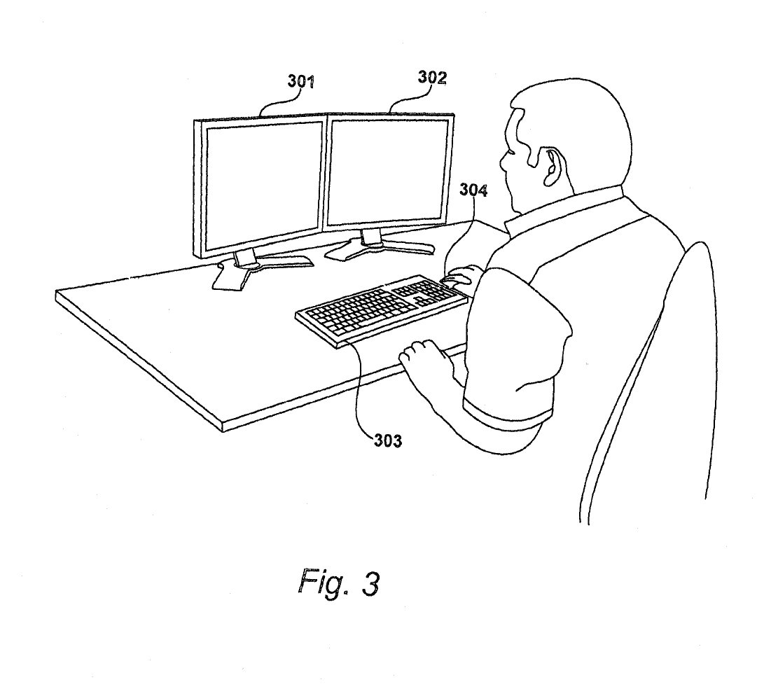

### FIG. 3

An example of a station for a character artist is shown in FIG. 3. The artist interfaces with a desktop based processing system of significant processing capability. Output data, in the form of a graphical user interface, is shown via a first output display 301 and a second output display 302. Input commands are provided to the station via a keyboard 303 and a mouse 304. Other input devices, such as a tracker ball or a stylus and touch tablet could be deployed.

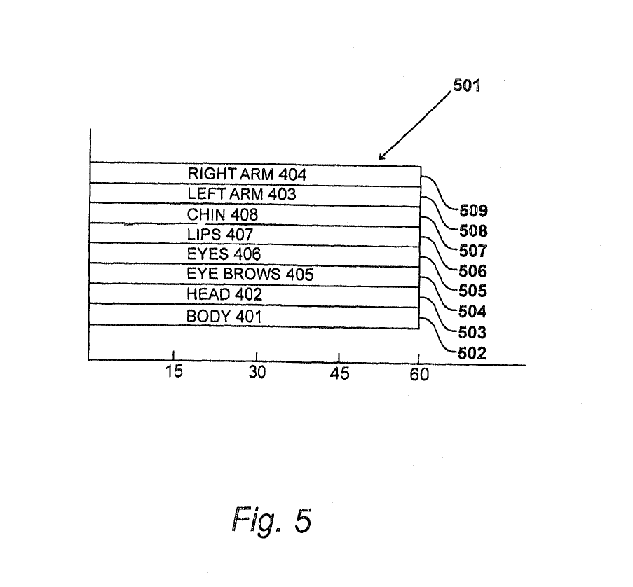

In a typical mode of operation, control menus may be displayed on the first display device 301 and a workspace may be displayed on the second output display 302. The workspace itself is typically divided into four regions, each showing different views of the same character being created. Typically, three of these show orthographic projections and a third shows a perspective projection. Within this environment, an artist is in a position to create a three dimensional scene that has characters, backgrounds and audio effects. In a preferred implementation, additional tools are provided, often referred to as ‘plug-ins’ that may establish rules for creating a scene so as to facilitate animation and facilitate the packaging of output data into a source data file, as illustrated in FIG. 5.

An artist takes the character and places the character in an animation scene. They make an animation loop of the character idling, that is to say just looking around and occasionally blinking. This consists of a few seconds (say two seconds) of animation that can be repeated or looped to fill in time when the character is not actually saying anything.

Items are moved within a scene using an animation timeline. Animation key frame techniques are used. A timeline is split into frames, typically working at thirty frames per second. Consequently, two seconds of animation will require sixty frames to be generated.

In the loop, different parts of the model, such as the arms, eyes and head, move in terms of their location, rotation, scale and visibility. All of these are defined by the animation timeline. For example, a part of the animation timeline may contain movement of the head. Thus, in a loop, the head may move up and down twice, for example. To achieve this, it may be necessary to define four key frames in the time line and the remaining frames may be generated by interpolation.

After creating an idle loop, the artist creates a speech loop. This is more animated and may provide for greater movement of the eyes of the character, along with other movements. However, at this stage, there is no audio data present, therefore the character artist at the graphics station is not actually involved with generating an animation that has lip synchronization. However, to allow lip synchronization to be achieved at the production stage, it is necessary to define additional animations that will occur over a range from zero extent to a full extent, dependent upon a value applied to a control parameter. Thus, a parameter is defined that causes the lips to open from zero extent to a full extent. The actual degree of lip movement will then be controlled by a value derived from the amplitude of an input speech signal at the production stage.

In order to enhance the overall realism of an animation, other components of the character will also move in synchronism with the audio; thereby modelling the way in which talent would gesticulate when talking. Furthermore, for character animations, these gesticulations may be over emphasised for dramatic effect. Thus, in addition to moving the lips, other components of the character may be controlled with reference to the incoming audio level. The ability to control these elements is defined at the character generation stage and specified by the character artist. The extent to which these movements are controlled by the level of the incoming audio may be controlled at the production stage.

The animation timeline has multiple tracks and each track relates to a particular element within the scene. The elements may be defined by control points that in turn control Bezier curves. In conventional animation production, having defined the animation over a timeline, a rendering operation would be conducted to convert the vector data into pixels or video data. Conventionally, native video data would then be compressed using a video CODEC (coder-decoder).

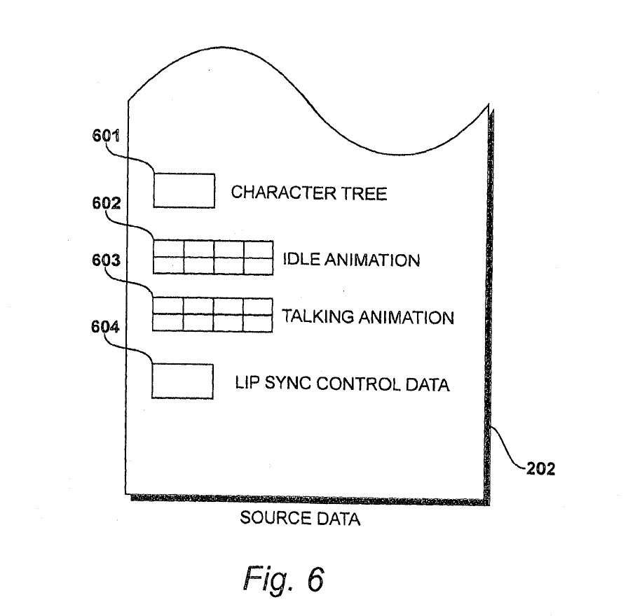

In an embodiment, the rendering operation is not performed at the graphics station. Furthermore, the graphics station does not, in this embodiment, produce a complete animated video production. The graphics station is responsible for producing source data that includes the definition of the character, defined by a character tree, along with a short idling loop, a short talking loop and lip synchronization control data. This is conveyed to the production station, such as station 111 as detailed in FIG. 6, which is responsible for producing the animation but again it is not, in this embodiment, responsible for the actual rendering operation.

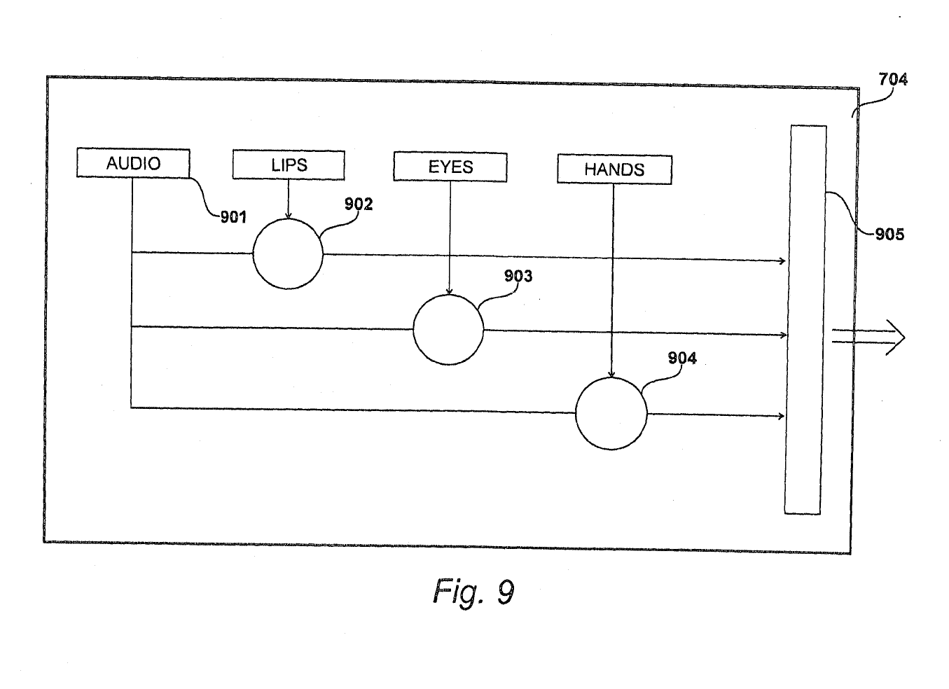

The rendering operation is performed at the end user device, as shown in FIG. 9. This optimises use of the available processing capabilities of the display device, while reducing transmission bandwidth; a viewer experiences minimal delay. Furthermore, this allows an end user to interact with an animation. It is also possible to further enhance the speed with which an animation can be viewed.

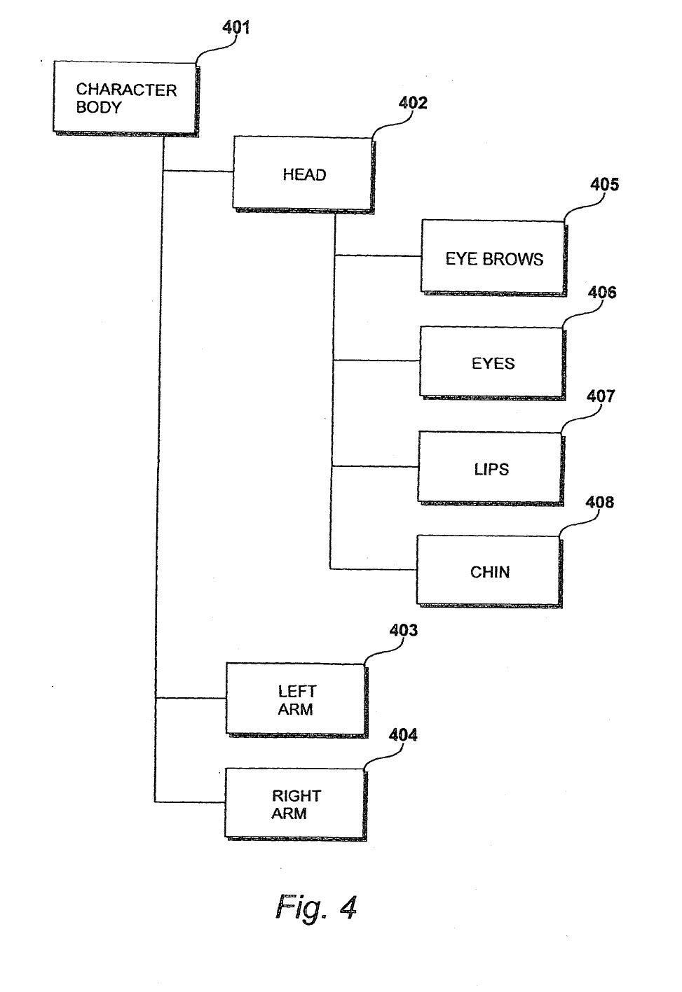

### FIG. 4

In an embodiment, each character is defined within the environment of FIG. 3 as a hierarchical model. An example of a hierarchical model is illustrated in FIG. 4. A base node 401 identifies the body of the character. In this embodiment, each animation shows the character from the waist up, although in alternative embodiments complete characters could be modelled.

Extending from the body 401 of the character there is a head 402, a left arm 403 and a right arm 404. Thus, any animation performed on the character body will result in a similar movement occurring to the head, the left arm and the right arm. However, if an animation is defined for the right arm 404, this will result in only the right arm moving and it will not affect the left arm 403 and the head 402. An animation is defined by identifying positions for elements at a first key frame on a timeline, identifying alternative positions at a second key frame on a time line and calculating frames in between (tweening) by automated interpolation.

For the head, there are lower level components which, in this example, include eyebrows 405, eyes 406, lips 407 and a chin 408. In this example, in response to audio input, controls exist for moving the eyebrows 405, the eyes 406 and the lips 407. Again it should be understood that an animation of the head node 402 will result in similar movements to nodes 405 to 408. However, movement of, say the eyes 406 will not affect the other nodes (405, 407, 408) at the same hierarchical level.

### FIG. 5

An example of a time line 501 for a two second loop of animation is illustrated in FIG. 5. The timeline is made up of a plurality of tracks, in this example eight are shown. Thus, a first track 502 is provided for the body 401, a second track 503 is provided for the head 402, a third track 504 is provided for the eyebrows 405, a fourth track 505 is provided for the eyes 406, a fifth track 506 is provided for the lips 407, a sixth track 507 is provided for the chin 408, a seventh track 508 is provided for the left arm 403 and an eight track 509 is provided for the right arm 404. Data is created for the position of each of these elements for each frame of the animation. The majority of these are generated by interpolation after key frames have been defined. Thus, for example, key frames could be specified by the artist at frame locations 15, 30, 45 and 60.

The character artist is also responsible for generating meta data defining how movements are synchronized with input audio generated by the producer. A feature of this is lip synchronization, comprising data associated with track 506 in the example. This is also identified by the term ‘audio rigging’, which defines how the model is rigged in order to respond to the incoming audio.

At this model creation stage, the rigging can be tested to see how the character responds to an audio input. However, audio of this nature is only considered locally and is not included in the source data transferred to the producers. Actual audio is created at the production stage.

### FIG. 6

An example of a source data file 202 is illustrated in FIG. 6. A specific package of instructions may be added (as a plug-in) to facilitate the generation of these source data files at the graphics station 109. After generation, character data are uploaded to the hosting server 108 and downloaded by the appropriate producer, such as producer 111. Thus, when a producer requires access to a source data file, in an embodiment, the source data file is retrieved from the hosting server 108. Animation data is generated and returned back to the hosting server 108. From the hosting server 108, the animation data is then broadcast to viewers who have registered an interest, such as viewers 101 to 106.

The source data file 202 includes details of a character tree 601, substantially similar to that shown in FIG. 4. In addition, there is a two second idle animation 602 and a two second talking animation 603. These take the form of animation timelines of the type illustrated in FIG. 5.

Furthermore, the lip synchronisation control data 604 is included. Thus, in an embodiment, all of the necessary components are contained within a single package and the producers are placed in a position to produce a complete animation by receiving this package and processing it in combination with a locally recorded audio file.

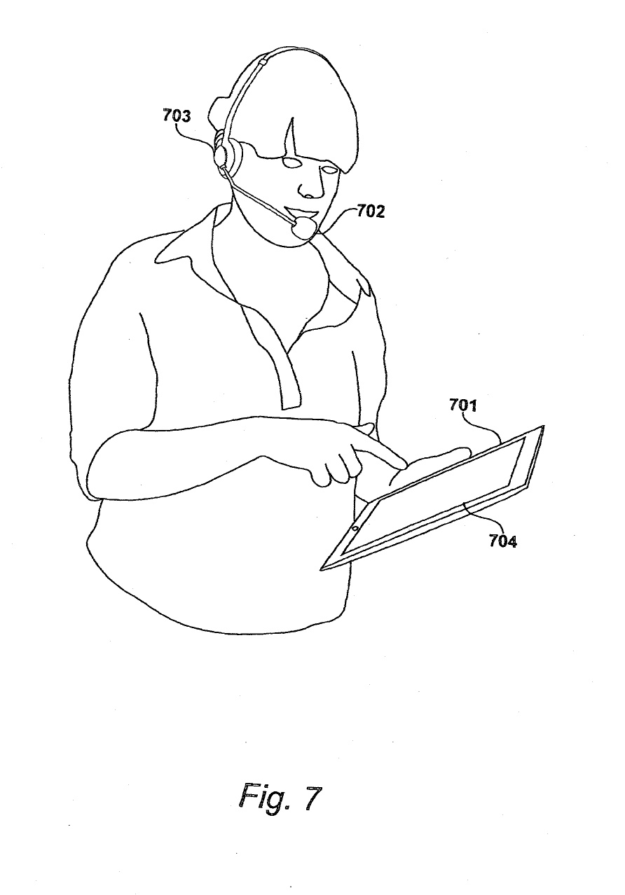

### FIG. 7

An example of a production station 701 is illustrated in FIG. 7. The required creative input for generating the graphical animations has been provided by the character artist at the graphic stations. Thus, minimal input and skill is required by the producer, which is reflected by the provision of the station being implemented as a tablet device. Thus, it is envisaged that when a character has been created for talent, talent should be in the position to create their own productions with a system automatically generating animation in response to audio input from the talent.

In this example, audio input is received via a microphone 702 and clips can be replayed via an earpiece 703 and a visual display 704. Audio level (volume) information of the audio signal received is used to drive parts of the model. Thus, the mouth opens and the extent of opening is controlled. Lips move, showing the teeth, from a fully closed position to a wide open position, for example. The model could nod forward and there are various degrees to which the audio data may affect these movements. It would not be appropriate for the character to nod too much, for example, therefore the nodding activity is smoothed by a filtering operation. A degree of processing is therefore preformed against the audio signal, as detailed in FIG. 9.

It is not necessary for different characters to have the same data types present within their models. There may be a preferred standard starting position but in an embodiment, a complete package is provided for each character.

In an embodiment, the process is configured so as to require minimal input on the part of the producer. However, in an alternative embodiment, it is possible to provide graphical controls, such as dials and sliders, to allow the producer to increase or decrease the affect of an audio level upon a particular component of the animation.

However, in an embodiment, the incoming audio is recorded and normalized to a preferred range and additional tweaks and modifications may be made at the character creation stage so as to relieve the burden placed upon the producer and to reduce the level of operational skill required by the producer. It is also appreciated that particular features may be introduced for particular animations, so as to incorporate attributes of the talent within the animated character.

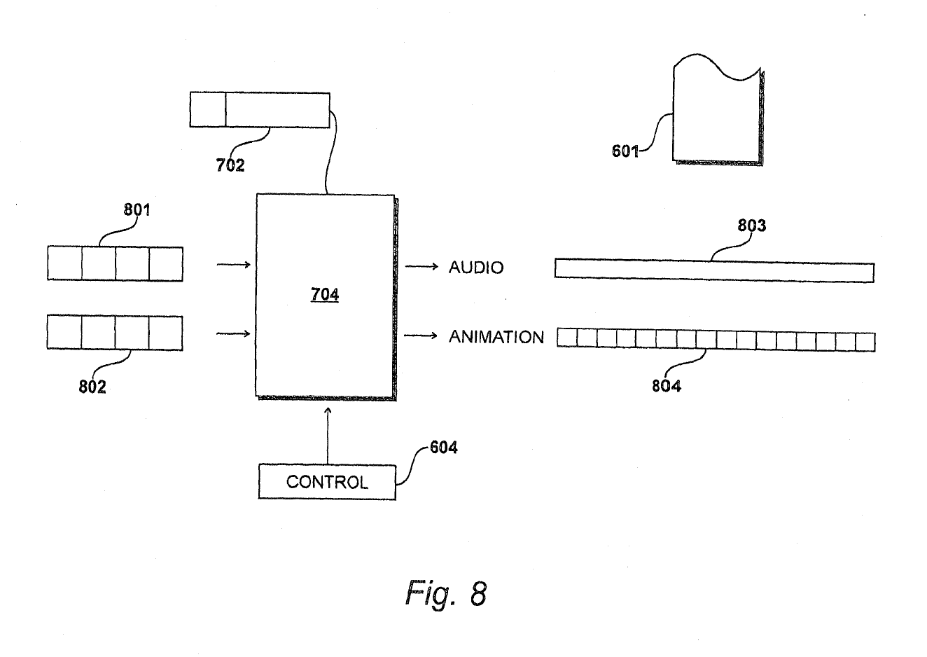

### FIG. 8

A schematic representation of the operations preformed within the environment of FIG. 7 is detailed in FIG. 8. The processing station 704 is shown receiving an animation loop 801 for the idle clip, along with an animation loop 802 for the talking clip. The lip synchronisation control data 604 is read from storage and supplied to the processor 704. The processor 704 also receives an audio signal via microphone 702.

In an embodiment, the audio material is recorded so that it may be normalized and in other ways optimized for the control of the editing operation. In an alternative embodiment, the animation could be produced in real-time as the audio data is received. However, a greater level of optimization, with fewer artefacts, can be achieved if all of the recoded audio material can be considered before the automated lip synching process starts.

An output from the production processing operation consists of the character tree data 601 which, in an embodiment, is downloaded to a viewer, such as viewer 106. Once and once installed upon the viewer's equipment, the character tree data is called upon many times as new animation data is received.

Each new animation includes an audio track 803 and an animation track 804. The animation track 804 defines animation data that in turn will require rendering in order to be viewed at the viewing station, such as station 106. This places a processing burden upon the viewing station 106 but reduces transmission bandwidth. The animation data 804 is selected from the idle clip 801 and the talking clip 802. Furthermore, when the talking clip 802 is used, modifications are made in response to the audio signal, so as to implement the lip synchronization. The animation data 804 and the audio track 803 may be synchronized using time code.

### FIG. 9

Activities preformed within production processor 704 are detailed in FIG. 9. The recorded audio signal is shown being replayed from storage 901. The audio is conveyed to a first processor 902, a second processor 903 and a third processor 904. As will be appreciated, a shared hardware processing platform may be available and the individual processing instantiations may be implemented in a time multiplexed manner.

Processor 902 is responsible for controlling movement of the lips in response to audio input, with processor 903 controlling the movement of the eyes and processor 904 controlling movement of the hands. The outputs from each of the processors are combined in a combiner 905, so as to produce the output animation sequence 804.

At each processor, such as processor 902, the audio input signal may be amplified and gated, for example, so as to control the extent to which particular items move with respect to the amplitude of the audio input.

For control purposes, the audio input signal, being a sampled digital signal, effectively be down sampled. so as to provide a single value for each individual animation frame. This value will represent the average amplitude (volume) of the signal during the duration of a frame, typically one thirtieth of a second.

The nature of the processes occurring will have been defined by the character artist (at the graphics station) although, in a alternative embodiment, further modifications may be made by the producer at a production station.

In an embodiment, the movement of the lips, as determined by processor 902, will vary substantially linearly with the volume of the incoming audio signal. Thus, a degree of amplification made be provided but it is unlikely that any gating will be required.

The movement of the eyes and the hands may be more controlled. Thus, gating may be provided, such that the eyes only move when the amplitude level exceeds a predetermined value. A higher level of gating may be provided for the hands, such that an even higher amplitude level is required to achieve hand movement but this may be amplified, such that the hand movement becomes quite violent once the volume level has exceeded this higher level.

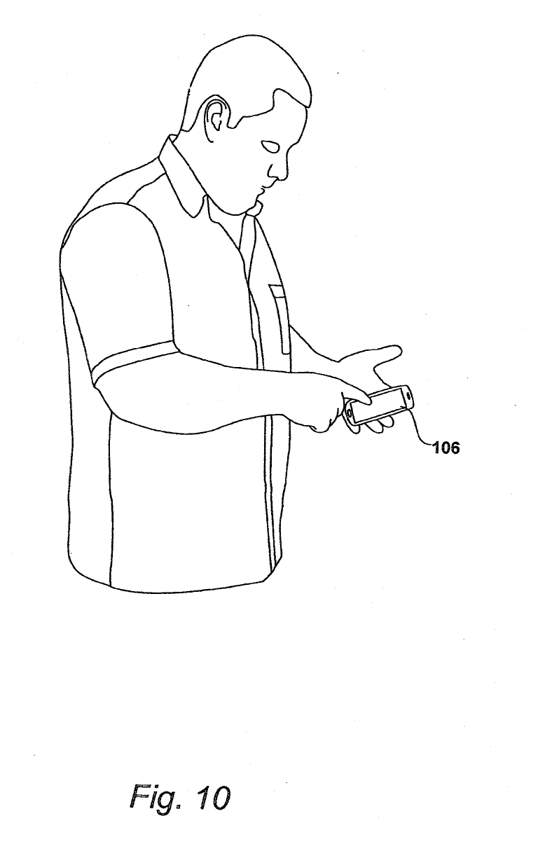

FIG. 10

An example of a display device 106 is shown in FIG. 10. In this example, the display device may be a touch screen enabled mobile cellular telephone, configured to decode received audio data 803 and render the animation data 804, with reference to the previously received character data 601.

In addition to viewing the display device 106, it is also possible for a user to interact with the display device 106. Thus, while an animation is being displayed, and actually rendered on the display device itself, it is possible for a user to provide additional input resulting in a change to the nature of the animation being viewed. Thus, while viewing an animation of a character talking, it is possible for a user to tap on the display device. Detection devices within the display device, such as accelerometers etc, detect that a tap has occurred. In response to receiving this tap, that representing second input data, rendering means are configured to render an animation in response to the character data and an alternative clip of animation.

As can be appreciated, this ability to interact with what appears to be a movie, at the display device itself, facilitates the introduction of many artistic procedures, along with opportunities for enhancing teaching situations and also providing an environment in which it is possible to receive data from the user, possibly allowing a user to make a selection or cast a vote etc. Thus, a character being displayed may ask a question and the animation that follows will be determined by whether an interaction has been detected or not.

It is also appreciated that the deployment of techniques of this type could be used for marketing purposes. Thus, a user could for example, be invited to make a purchase which will be acknowledged when a tap occurs. Thus, a character could actively encourage a purchase to be made and user responses can be captured.

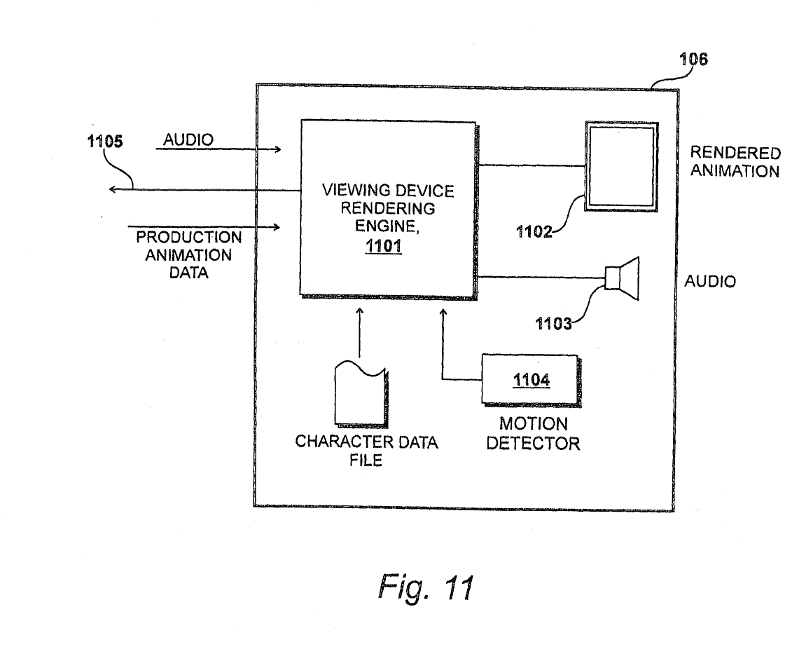

### FIG. 11

A schematic representation of the viewing device 106 is shown in FIG. 11. A processor contained within the viewing device 106 effectively becomes a rendering engine 1101, configured to receive the encoded audio data and the animation data.

Character data has previously been received and stored and is made available to the rendering engine 1101. Operations are synchronized with the rendering engine with respect to the established time code, so as to supply video data to an output display 1102 and audio data to a loudspeaker 1103.

As provided in many devices, such as cellular mobile telephones, a motion detector 1104 is provided. In an embodiment, the motion detector 1104 may be implemented using one or more accelerometers. In this way, it is possible for the device 106 to detect that a tap has occurred, or a physical shake has occurred, such that an input signal is provided to the rendering engine 1101.

In this way, a display device is configured to display audio and visual data representing a character animation. There is a first input configured to receive character data, primary animation data, primary audio data and an alternative clip of animation data. The rendering engine is configured to render an animation in response to the character data, the primary animation data and the primary audio data. A second input device 1104 receives a manual input from a user. The rendering engine 1101 is configured to render an animation in response to the character data and the alternative clip of animation data, having received second input data from the second input means.

In the example shown, the display device is a mobile device and in particular a mobile cellular telephone. As an alternative, the device could be a touch tablet, an audio player or a gaming device etc.

In an alternative embodiment, the second input means is a conventional input device, possibly connected to a conventional computer, and taking the form of a mouse, a keyboard, a tracker ball or a stylus etc.

In the embodiment shown, the input device is incorporated within the mobile device and manual input is received by manual operations being preformed upon the device itself; a tap being illustrated in the example. Other input movements may be performed, such as a shake or a gesticulation performed upon a touch sensitive screen. As is known in the art, this may involve the application of a single finger or multiple fingers upon the screen of device 106

In an embodiment, it is possible for the primary audio data to continue to be played while the alternative animation clip is being rendered. However, as an alternative, it is possible to play alternative audio data while the alternative clip of animation data is being rendered. Thus, as an example, it is possible for a character to appear to fall in response to a tap. The character would then be seen picking themselves up and possibly making noises of complaint. The normal animation will then resume where it left off.

In an embodiment, the rendering device is configured to generate in between frames of visual data when transitioning between the rendering of the primary animation data and the alternative clip of animation data. Thus, greater realism is achieved if, following the previous example, a tap causes a character to fall. The tap may have occurred at any position within the primary animation. The alternative animation starts at a particular character location. Thus, it is preferable for the character to be seen smoothly transitioning from the position at which that tap occurred to the position defined by the start of the alternative animation. In response to receiving a tap, for example, the alternative animation may emulate the tap being received as a punch. Thus, the animated character could appear as if punched and thereby respond by falling over. In addition, alternative audio may be provided for this punching action. Thus, this would include the audio noise of the punch itself followed by noises generated by the falling operation.

In an embodiment, it is also possible for the display device to produce an output signal in response to receiving the manual input signal. In this way, it is possible to convey a signal back, as illustrated at 1105, to a server indicating that an interaction has taken place. Such an environment may be deployed for purposes of voting or making sales etc.

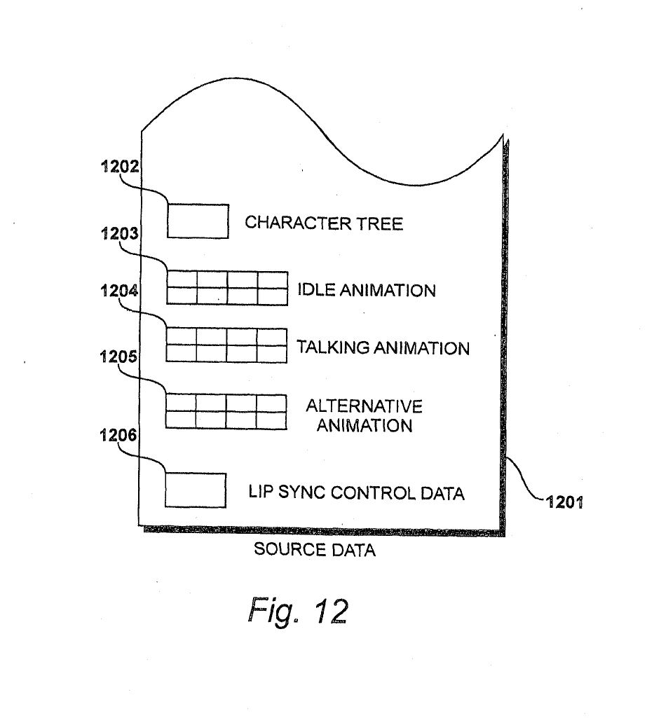

### FIG. 12

An alternative source data file 1201 is shown in FIG. 12, substantially similar to the data source file shown in FIG. 6. The source data file 1201 includes a character tree 1202, of the type shown in FIG. 4. There is a two second idle animation loop 1203 and a two second talking animation loop 1204. Again, these take the form of animation timelines of the type illustrated in FIG. 5.

In addition, in this embodiment, there is provided an alternative animation 1205. It should also be appreciated that, in alternative embodiments, a plurality of alternative animations may be provided. These allow an alternative animation to be selected and rendered at the display device as an alternative to a currently running animation in response to an input signal generated by a user action, such as a tap.

Thus, in an embodiment, the graphics station produces character animation data by generating means configured to generate an animatable character data set, a primary animation loop for deployment with subsequently produced audio data and an alternative animation clip for deployment upon detection of a manual input at the display device. In this way, a rendering step is modified at the display device in response to receiving a manual input. This is then viewed, via output means, by conveying data generated by the generating means.

The source data file 1201 also includes lip synchronization control data 1206. As in the previous embodiment, all of the necessary components are contained within a single package and the producers, such as the producer at station 111, are placed in a position enabling them to produce a complete animation by receiving this package and processing it in combination with a locally recorded audio file.

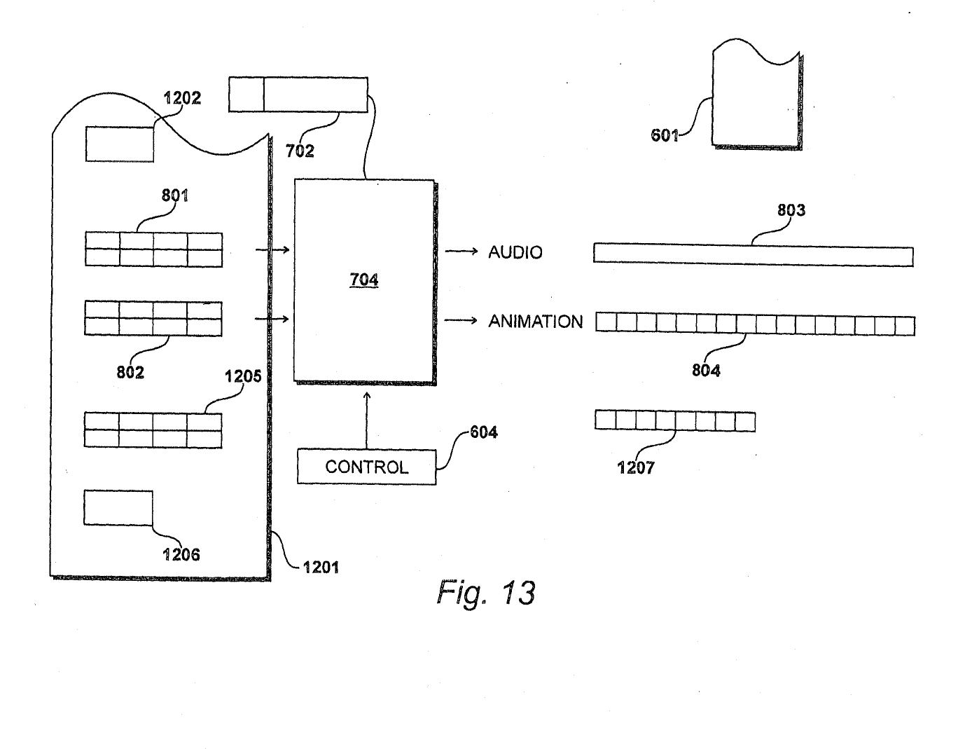

### FIG. 13

An alternative schematic representation of operations performed within the environment of FIG. 7, in accordance with an alternative embodiment, is detailed in FIG. 13. FIG. 13 includes all of the components present within the embodiment shown in FIG. 8, therefore referenced numerals shown in FIG. 8 have been retained in FIG. 13. The production station receives the source data file 1201, that includes the animatable-character data 1202, a primary animation loop and an alternative animation clip 1205. In this embodiment, both the idle animation loop 1203 and the talking animation loop 1204 may be considered as examples of the primary animation loop.

Second input means, in the form of microphone 702, is provided for receiving an audio signal. Processing means generates animation data 601 renderable at the display device by processing the primary animation loop 802 in combination with the audio signal received from microphone 702.

At the production station, it is possible for a producer to allow the alternative animation clip to be available or to disable this clip. By enabling the use of the alternative animation clip, the animation clip input data 1205 in the source data is conveyed, as illustrated at 1207, to the output data file. Thus, in this way, the alternative animation clip becomes available as an alternative to the primary animation loop during the rendering process. This alternative clip is selected in response to decting a specified form of manual input at the display device. The nature of this manual input, in an embodiment, is specified by the originating graphics station. In an alternative embodiment, the nature of this manual input is determined at the production station.

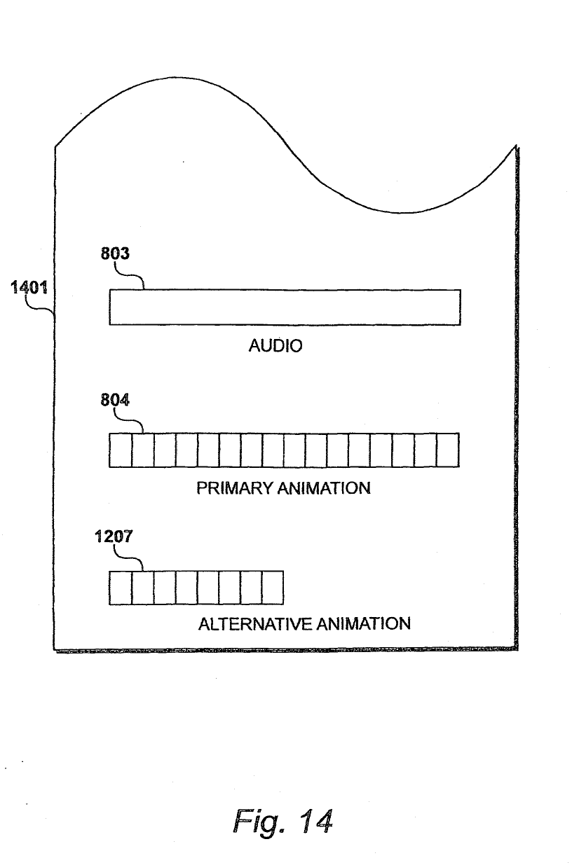

### FIG. 14

As previously described, character tree data 601 is, in a preferred embodiment, conveyed to an end user display device once and retained in non-volatile memory at the display device 106. A source data file 1201 is processed to produce audio data 803, primary animation data 804 and alternative animation data 1207. As shown in FIG. 14, the audio data 803, the primary animation data 804 and the alternative animation data 1207 may be grouped together in a file 1401 for transmission from a production station (such as station 110) to the hosting server 108, via network 107.

In an embodiment, it would be possible for file 1401 to be downloaded to a display device, such as display device 101. As previously described, the display device has received the character data 601 therefore upon receiving the specific production assets, contained within file 1401, it is possible for the display device to render the animation and thereby present it to a user, as shown in FIG. 10. However, it is possible for the data volume of file 1401 to become relatively large, therefore a noticeable amount of time would elapse while performing the downloading process.

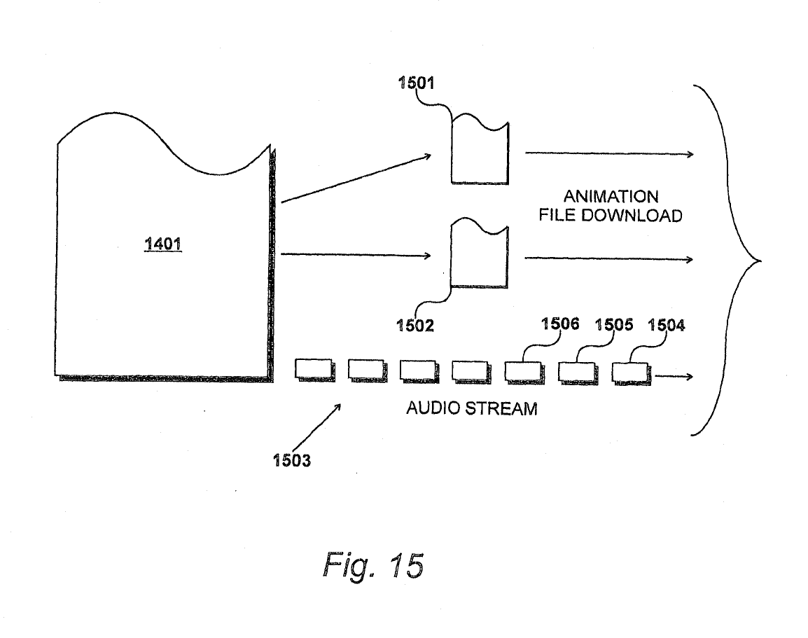

### FIG. 15

Procedures performed at the hosting server 108 in an embodiment for downloading audio and visual data to an end user display device is illustrated in FIG. 15. For the purposes of this example, it is assumed that the character data has been downloaded to the end user and stored in memory at the end user device. Thus, character data file 601 is available at the end user device.

In order for the animation to be shown at the end user device, the animation data is downloaded as an animation data file. In the example showed in FIG. 15, a primary animation file 1501 is downloaded, along with an alternative animation data file 1502. Thus, in combination, these represent the animation file downloads.

Having downloaded the animation data, it is possible for the visual aspect of the animation to be displayed at the end user device. However, the full animation cannot be displayed at this point because the audio data has not been downloaded.

In many examples, the total volume of the animation data, even when compressed, will be larger than the animation data, given that the majority of the fine texture and bandwidth consuming material will be derived from the character data 601 already resident.

In order for the animation to be displayed quickly, the audio data is streamed to the end user device, as illustrated by audio stream 1503. As is known in the art, the audio stream 1503 is made up of a plurality of packets consisting of a first packet 1504, a second packet 1505 and a third packet 1506 etc.

Rendering operations are performed at the end user device in terms of rendering the visual material and rendering the audio material. The audio material is compressed and a de-compression process is performed using an appropriate CODEC. In an embodiment, a CODEC is chosen where it is possible for the decoding operation to be performed as the audio material is received. Thus, it is not necessary for the whole of the audio file to have been received before the decoding process can be initiated. Consequently, the animation data is rendered in response to the character data file, the animation data file and the audio data as the audio data is received. Thus, in this way, the rendering process is initiated before the whole of the audio data has been received.

The presentation of the animated character appears to an end user as being received substantially instantaneously, given that it is not necessary for the end user to wait for all of the animation data to be received. The visual data is received as a download and then the animation is created as the audio data is received as an audio stream.

Having downloaded the character data file 601, this character data may be used many times in response to a plurality of downloaded animation data files and associated streamed audio files. It is also possible for a plurality of downloaded character data files to be stored for a particular character and a specific character data file to be selected by selection data contained within the downloaded animation data file. Furthermore, it is possible for the downloaded animation data file to sequentially select a plurality of the downloaded character data files.

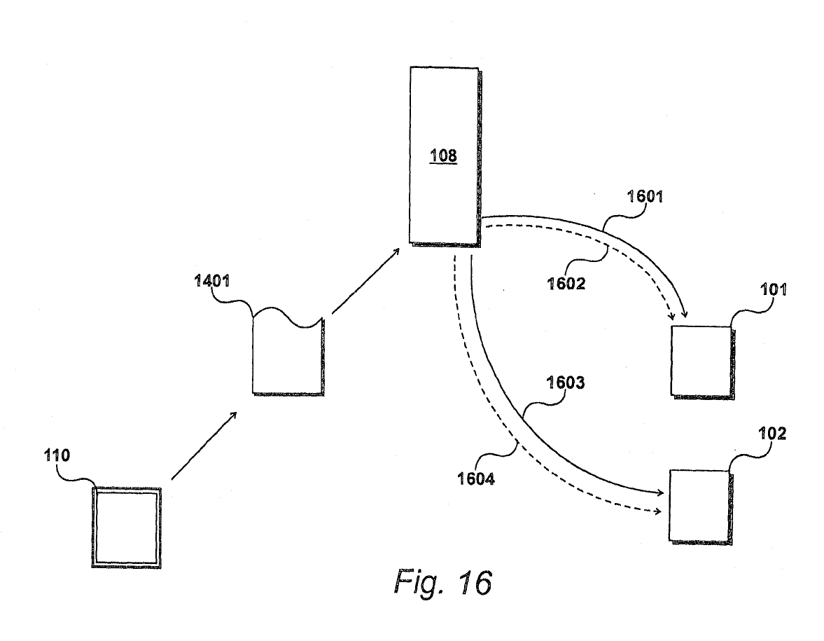

### FIG. 16

The hosting server 108 is shown in FIG. 16, which may be considered as a data distribution apparatus for the distribution of data to end user display devices, including end user display devices 101 and 102. In this embodiment, the data distribution apparatus is configured to upload character data to the end user devices as a character data file 601. As previously described, this is performed once, whereafter it is possible to upload a plurality of animation data files. For the sake of clarity, in the environment shown in FIG. 16, the data is being uploaded to the user devices, representing the same process, from the perspective of the end user devices, as this data being downloaded by them.

Thus, in the example shown in FIG. 16, animation data in the form of an animation file is transmitted, as shown as 1601, from the distribution apparatus 108 to the end user device 101. This is then followed by a stream 1602 of audio data that is being supplied from the distribution apparatus 108 to the end user device 101. Thus, the streamed audio data is associated with the downloaded animation data. The end user device is allowed to render the animation data is response to the character data file, the animation data file and the streaming audio data. In this way, the rendering process starts before the whole of the audio data has been streamed.

A similar process is performed with respect to end user device 102. Thus, again, the animation data is downloaded 1603 as a file and a stream 1604 of audio data follows thereafter, such that it is possible for the rendering process to be initiated before all of the audio data has been received.

It is also appreciated that the processes shown in FIG. 16, in terms of animation data download followed by audio streaming, may be repeated many times after the character data file 601 has been transmitted.

The audio data may be streamed in a compressed data format and in an embodiment, the audio data may be streamed in a multi-channel format, such as a stereo format.

In an embodiment, the character data, the animation data and the audio data are derived from a production station 110 but the character data will have been received at the production station from a graphics station and the graphics station will have provided the production station with the animation loops. The character data and the animation loops are uploaded to the production station to allow the production station to create animation data in response to audio data generated at the production station.

Each display device, such as display device 101, is configured to download character data and to download animation data. The display devices include facilities for rendering a displayable animation in response to the character data file and the animation data file, while receiving a stream of associated audio data. In this way, the rendering operation starts to produce displayable data, with audio, before the whole of the audio data has been received. The character data may be stored in local memory at the display device, whereafter a plurality of sets of animation data may be received, each of which makes use of the previously stored character data.

In an embodiment, it is possible for the display device 101 to store a plurality of downloaded character data files for a particular character. The rendering facility then selects a specific character data file in response to a selection instruction contained within a downloaded animation data file. Furthermore, in an embodiment, it is possible for a downloaded animation file to include sequential selection instructions for selecting a plurality of downloaded character data files forming part of a unified animation.

In an embodiment, it is also possible for a mobile display device, such as device 101, to make a request the server 108 so as to be provided with instructions, via a download process, such that, when installed, the mobile display device 101 is provided with the functionality of a production station, such as production station 110. In this way, it is possible for end users to create their own animations.

When end users make their own animations, it would be possible for them to construct or commission their own animatable character. However, in an embodiment, a stock of characters may be made available for end users to deploy with their own audio input. In this way, messages can be sent between users such that, when played, the message is seen and heard as a talking animal, for example, with the voice of the originator of the message.

1. Apparatus for conveying an audio message to a plurality of mobile display devices, comprising:
a graphics station,
an internet server and
a production device,
wherein said graphics station, in response to a manual input, is configured to:
create a character data file for a character having animatable lips;
generate a speech animation loop having a lips control for moving said animatable lips in response to a control signal; and
upload said character data file and said speech animation loop to said internet server;
wherein said production device is configured to:
obtain said character data file and said speech animation loop from said internet server;
receive local audio to produce associated audio data and said control signal to animate the lips;
construct a primary animation data file with lip movement, from character data from said character data file, said speech animation loop and said control signal; and
transmit said primary animation data file and said associated audio data to said internet server; and
wherein each said mobile display device is configured to:
receive said character data from said internet server;
accept said primary animation data file and said associated audio data from the internet server;
process said character data file and said primary animation data file to produce primary rendered video data; and
play said primary rendered video data with said associated audio data, such that the movement of said lips shown in said primary rendered video data when played is substantially in synchronism with the audio being played.

2. The apparatus of claim 1, wherein:
said graphics station is configured to generate an idle animation loop; and
said production device is configured to produce said primary animation data file from said idle animation loop and said speech animation loop.

3. The apparatus of claim 1, wherein said graphics station is also configured to produce an alternative animation sequence and each said mobile display device is configured to:
receive said alternative animation sequence;
respond to a manual action by producing alternative rendered video data; and
play said alternative rendered video data as an alternative to said primary rendered video data.

4. The apparatus of claim 3, wherein:
said graphics station is also configured to produce an alternative audio data file;
each said mobile display device is configured to receive said alternative audio data file; and
each said mobile display device is configured to play said alternative audio data file with said alternative rendered video data.

5. The apparatus of claim 4, wherein the playing of said primary rendered video data resumes after the playing of said alternative rendered video data.

6. The apparatus of claim 1, wherein the character data is received once and many first animation data files are accepted with associated audio data, wherein each example of a first animation data file is rendered to video with use of a single instance of said character data.

7. The apparatus of claim 1, wherein:
said internet server is configured to download instructions to a requesting mobile display device; and
upon installing said instructions, said requesting mobile display device is provided with a functionality of said production device.

8. The apparatus of claim 1, wherein:
an animation file is accepted as a downloaded file;
audio data is accepted by a process of streaming; and
the audio data is played substantially in synchronism with the rendered video data while the audio data is being streamed.

9. A method of conveying an audio message to a plurality of mobile display devices, comprising the steps of:
(a) receiving a manual input at a graphics station, such that said graphics station performs the steps of:
creating a character data file for a character having animatable lips; and
generating a speech animation loop having a lips control for moving said animatable lips in response to a control signal;
(b) uploading said character data file and said speech animation loop from said graphics station to an internet server;
(c) downloading said character data file and said speech animation loop from said internet server to a production device;
said production device performing the steps of:
receiving local audio;
producing associated audio data, and said control signal to animate the lips from said audio data;
constructing a primary animation data file with lip movement, from character data from said character data file, said speech animation loop and said control signal;
(d) transmitting said primary animation data file and said associated audio data from said production device to said internet server;
(e) at each mobile display device, receiving said character data and accepting said primary animation data file and said associated audio data from the internet server; and
(f) each mobile display device performs the steps of:
processing said character data file with said primary animation data file to produce primary rendered video data; and
playing said primary rendered video data with said associated audio data, such that the movement of the lips shown in said primary rendered video data when played is substantially in synchronism with the audio being played.

10. The method of claim 9, wherein said production device:
produces a first control signal for said lips animation; and
produces a second control signal for controlling at least one other animatable component defined within the character data file.

11. The method of claim 9, wherein:
said graphics station produces an idle animation loop; and
said production device produces the primary animation file using both said speech animation loop and said idle animation loop.

12. The method of claim 9, wherein each mobile display device:
receives the character data once; and
accepts many primary animation data files with associated audio data.

13. The method of claim 9, wherein:
the graphics station produces an alternative animation sequence; and
each mobile display device:
downloads said alternative animation sequence;
responds to a manual action by producing alternative rendered video data; and
plays said alternative rendered video data as an alternative to said primary rendered video data.

14. The method of claim 9, wherein said primary animation data file is accepted as a download and said associated audio data is streamed.

15. The method of claim 9, further comprising the steps of:
receiving a request at said internet server from a mobile display device for additional functionality; and, in response to said request,
downloading instructions to a requesting mobile display device to provide said mobile display device with the functionality of a production device to perform the steps of:
downloading said character data file and said speech animation loop from said internet server to the production device;
said production device performing the steps of:
receiving local audio;
producing associated audio data, and said control signal to animate the lips from said audio; and
constructing a primary animation data file with lip movement, from said character data, said speech animation loop and said control signal.

16. A method of playing an audio message at a mobile display device, comprising the steps of:
receiving a character data file,
downloading a primary animation data file,
downloading an alternative animation sequence and accepting audio data associated with said primary animation file;
processing said character data file with said primary animation data file to produce primary rendered video data;
playing said primary rendered video data with said associated audio data, such that the movement of lips shown in the primary rendered video data when played is substantially in synchronism with the audio being played;
responding to a mechanical interaction by producing alternative video data from said alternative animation sequence; and
playing said alternative video data instead of said primary rendered video data.

17. The method of claim 16, wherein:
an alternative audio data file is produced;
each mobile display device receives said alternative audio data file; and
each mobile display device plays said alternative audio data file with said alternative rendered video data.

18. The method of claim 16, wherein the playing of said primary rendered video data resumes after the playing of said alternative rendered video data.

19. A method of playing an audio message at a mobile display device, comprising the steps of:
receiving a character data file;
downloading a primary animation file;
processing said character data file with said primary animation file to produce primary rendered video data; and
playing said primary rendered video data with associated audio data, and
streaming said associated audio data, such that the playing of video with substantially synchronised audio is initiated before all of the audio data has been received.

20. The method of claim 19, further comprising the steps of:
downloading an alternative animation sequence to the mobile display device with alternative audio data;
detecting a manual action performed upon the mobile display device;
deriving alternative rendered video data from said alternative animation sequence and playing said alternative rendered video data with alternative audio data; and
resuming the playing of said primary rendered video with streamed associated audio data.
